(19) United States
(12) Patent Application Publication
(10) Pub. No.: US 2024/0203293 A1
(43) Pub. Date: Jun. 20, 2024

(54) LASER-PRINTED IN-MOLD LABEL

(71) Applicant: TOYOBO CO., LTD., Osaka (JP)

(72) Inventors: Shintaro ISHIMARU, Fukui (JP); Masayuki HARUTA, Fukui (JP)

(73) Assignee: TOYOBO CO., LTD., Osaka (JP)

(21) Appl. No.: 18/287,246

(22) PCT Filed: Mar. 16, 2022
(86) PCT No.: PCT/JP2022/012055

§ 371 Date: Oct. 17, 2023

(30) Foreign Application Priority Data
Apr. 23, 2021 (JP) 2021-073607

(51) Int. Cl. G09F 3/02; G09F 3/04

(52) U.S. Cl. CPC G09F 3/02; G09F 3/04; G09F 2003/0201; G09F 2003/0225

(57) ABSTRACT

Provided is an in-mold label capable of recognizing the content thereof even when a display size is reduced as a container is downsized. The in-mold label comprises at least one laser-printed layer capable of being printed by laser irradiation. The laser-printed layer includes a laser-printed portion and a non-printed portion, and an absolute value of a difference between color L* values of the printed portion and the non-printed portion is 1.0 or more and 10.0 or less.

### TECHNICAL FIELD

The present invention relates to an in-mold label comprising a layer printed by laser.

### BACKGROUND ART

Conventionally, containers made of plastic films have widely used for distribution goods typified by foods, medicines and industrial products. Most of these containers not only protect contents but also have the role of displaying (hereinafter sometimes referred to as “printing”) information pertaining to a product name, manufacturing date, and raw materials and the like.

In recent years, research has been actively conducted on a container with in-mold label in which a label as a display body is simultaneously bonded to integrate the label and the container when manufacturing the container. In general, in-mold labels on which designs and characters are displayed in advance are used. In recent years, due to an increase in environmental awareness, a container that becomes waste after use has been downsized. Therefore, while the display area inevitably decreases, there is a problem that display contents required for product distribution such as names of raw materials, production lots, and handling precautions cannot be reduced.

Therefore, for example, Patent Document 1 discloses a label for in-mold forming in which two or more labels are stacked and can be peeled off in order to improve a display area. The use of such an in-mold label increases the display area, which is preferred, but the amount of waste increases by the amount of the peeled label, and therefore the use of the in-mold label is not preferred in terms of environmental problems. In addition, when such a label is actually used, there have been cases where time and effort for peeling the label increase, and difficulty in peeling the label becomes a problem.

Therefore, in order to display desired contents without increasing the display area in this manner, there is an attempt to reduce the display size itself. As a display technique, printing with ink or the like is generally widely used. However, for example, when an attempt is made to reduce the display size by printing, there is a problem that it is difficult to recognize the display contents because gaps between lines forming the display contents are filled (for example, when the display is a character, the character is collapsed).

### PRIOR ART DOCUMENT

### Patent Document

Patent Document 1: JP-B-6184742

### SUMMARY OF THE INVENTION

### Problems to be Solved by the Invention

It is an object of the present invention to solve the problems of the conventional art such as the foregoing. That is, an object of the present invention is to provide an in-mold label capable of recognizing the content thereof even when a display size is reduced as a container is downsized.

### Means for Solving the Problems

The present invention is constituted as follows.

1. An in-mold label comprising at least one laser-printed layer capable of being printed by laser irradiation, wherein the laser-printed layer includes a laser-printed portion and a non-printed portion, and an absolute value of a difference between color L* values of the printed portion and the non-printed portion is 1.0 or more and 10.0 or less.

2. The in-mold label according to 1, wherein at least one of bismuth, gadolinium, neodymium, titanium, antimony, tin, and aluminum as a simple substance or an oxide is contained as a metal capable of being printed by laser irradiation.

3. The in-mold label according to 1 or 2, wherein a thickness of the laser-printed layer is 5 μm or more and 200 μm or less.

4. The in-mold label according to any one of 1 to 3, wherein either a height or a width of a print size in the printed portion is 0.2 mm or more and 100 mm or less.

5. The in-mold label according to any one of 1 to 4, wherein a resin constituting the laser-printed layer is mainly any one of polyester, polypropylene, polyethylene, and polystyrene.

6. The in-mold label according to any one of 1 to 5, wherein the in-mold label is bonded to a container, and has bonding strength with the container of 2 N/15 mm or more and 20 N/15 mm or less.

7. A container with in-mold label, wherein the in-mold label according to 6 is bonded to the container.

### Effect of the Invention

According to the present invention, it is possible to provide an in-mold label capable of recognizing the content thereof even when a display size is reduced.

### MODE FOR CARRYING OUT THE INVENTION

Hereinafter, an in-mold label of the present invention will be described.

### 1. Configuration of In-Mold Label

### 1.1. Configuration and Thickness of Layer

The in-mold label of the present invention should comprise at least one laser-printed layer capable of being printed by laser irradiation, and at least a part of the laser-printed layer should include a laser-printed portion and a non-printed portion.

In the in-mold label of the present invention, other layers may be laminated in addition to the laser-printed layer. In particular, considering that the in-mold label is formed to be bonded to a container, it is preferred that a heat seal layer is provided on any one of the surfaces of the in-mold label. The in-mold label of the present invention may include a substrate layer for the purpose of improving mechanical strength and scratch resistance of the surface, and a printed layer for the purpose of improving designability. Here, the printed layer is a layer on which characters and patterns other than printing formed by laser are described. Moreover, in the in-mold label of the present invention, a gas barrier layer and an overcoat layer laminated on the gas barrier layer can also be provided as necessary in addition to the above. These preferred requirements will be described later. In order to improve properties such as printability and lubricity of the surface, all layers constituting a packaging of the present invention can be provided with layers subjected to corona treatment, coating treatment, flame treatment, and the like, and these layers can be provided optionally within the scope of the requirements of the present invention.

The thickness of the in-mold label is not particularly limited, but is preferably 5 μm or more and 200 μm or less. When the thickness of the in-mold label is less than 5 μm, the mechanical strength and heat-sealing strength of the in-mold label may be inadequate, which is not preferred. The thickness of the in-mold label may be more than 200 μm, but the cost of the material to be used increases accordingly, which is not preferred. The thickness of the in-mold label is more preferably 10 μm or more and 195 μm or less, and still more preferably 15 μm or more and 190 μm or less.

The thickness of the laser-printed layer constituting the in-mold label of the present invention is preferably 3 μm or more and 190 μm or less. When the thickness is less than 3 μm, the visual perceptibility of laser printing may be diminished even when the concentration of a laser-printed pigment to be described later is increased. Meanwhile, when the thickness of the printed layer exceeds 190 μm, the volume of the film that absorbs the laser is extremely large and causes great damage, and therefore the deformation or perforation of the in-mold label may occur. The thickness of the printed layer is more preferably 10 μm or more and 180 μm or less, and still more preferably 15 μm or more and 170 μm or less.

### 1.2. Laser Printed Layer

### 1.2.1. Types of Laser-Printed Pigments, Amounts Thereof Added, and Methods for Adding Same

In order that the laser-printed layer constituting the present invention can be laser-printed, a laser-printed pigment having functionality permitting change in color when acted on by laser irradiation must be added thereto. Plastics constituting the laser-printed layer usually hardly react with laser light, and therefore cannot be printed by laser irradiation. The laser-printed pigment can be made to undergo excitation by the energy from laser light, making it possible for printing to take place as a result of carbonisation of the surrounding plastic. Besides the plastic carbonisation effect, there are laser-printed pigments which, depending on the type thereof, may themselves change color and become black. Simple or complex action of this carbonisation effect and laser-printed pigment color change effect makes it possible for printing to be carried out at the laser-printed layer. From the standpoint of printing density, it is preferred that a laser-printed pigment having both the plastic carbonisation effect and the effect whereby it itself changes color is selected.

Specific examples of the types of the laser-printed pigments include one of bismuth, gadolinium, neodymium, titanium, antimony, tin, and aluminum as a simple substance or an oxide. Among these, titanium oxide, calcium carbonate, bismuth trioxide, antimony trioxide, and barium sulfate are preferred, and titanium oxide, calcium carbonate and bismuth trioxide are more preferred. It is preferred that the particle diameter of the laser-printed pigment is 0.1 μm or more and 10 μm or less. When the particle diameter of the laser-printed pigment is less than 0.1 μm, there is a possibility that change in color during laser irradiation is not adequate. Meanwhile, when the particle size of the laser-printed pigment exceeds 10 μm, there is a concern that the clogging of a filter in an extrusion step when the component (film) of the in-mold label is formed is accelerated. The particle diameter of the laser-printed pigment is more preferably 1 μm or more and 9 μm or less, and still more preferably 2 μm or more and 8 μm or less.

The amount of the laser-printed pigment added to the laser-printed layer is preferably 0.05% by mass or more and 50% by mass or less. When the amount of the pigment added is less than 0.05% by mass, the printing density produced by the laser is not adequate, which is not preferred. Meanwhile, when the amount of the pigment added exceeds 50% by mass, the amount (volume) of carbonized plastic is relatively decreased, which may also result in inadequate printing density. The amount of the laser-printed pigment added is more preferably 0.1% by mass or more and 49% by mass or less, still more preferably 0.15% by mass or more and 48% by mass or less, and particularly preferably 0.2% by mass or more and 47% by mass or less.

As a method for blending the laser-printed pigment, the laser-printed pigment can be added at any stage during the manufacture of a resin to be a raw material for the laser-printed layer or a film to be the laser-printed layer. For example, with regard to a step during manufacture of a resin, methods in which a vented kneader extruder is used to cause a plastic raw material and a slurry in which particles thereof are dispersed in a solvent to be blended, methods in which a kneader extruder is used to cause dried particles thereof and plastic resin to be blended (made into masterbatch), and so forth may also be cited. Among these, methods in which a masterbatch that contains a laser-printed pigment is used as a film raw material are preferred.

### 1.2.2. Types of Plastic

The type of the plastic constituting the laser-printed layer of the present invention is not particularly limited, and any type of the plastic can be freely used without departing from the gist of the present invention. Examples of the type of the plastic (resin) include polyester, polyolefin, polystyrene, polyvinyl chloride, and polyamide.

Examples of the polyester include polyethylene terephthalate (PET), polybutylene terephthalate (PBT), polyethylene naphthalate (PEN), polytrimethylene terephthalate (PTT), polybutylene naphthalate (PBN), polylactic acid (PLA), polyethylene furanoate (PEF), and polybutylene succinate (PBS). Moreover, in addition to the polyesters cited at the foregoing examples, modified polyesters in which the monomer at such acid site or diol site is altered may also be used. Examples of the acid-site monomer include isophthalic acid, 1,4-cyclohexanedicarboxylic acid, 2,6-naphthalenedicarboxylic acid, orthophthalic acid, and other such aromatic dicarboxylic acids, adipic acid, azelaic acid, sebacic acid, decanedicarboxylic acid, and other such aliphatic dicarboxylic acids, and alicyclic dicarboxylic acids. Examples of the diol-site monomer include neopentyl glycol, 1,4-cyclohexanedimethanol, diethylene glycol, 2,2-diethyl-1,3-propanediol, 2-n-butyl-2-ethyl-1,3-propanediol, 2,2-isopropyl-1,3-propanediol, 2,2-di-n-butyl-1,3-propanediol, hexanediol, 1,4-butanediol, and other such long-chain diols, hexanediol and other such aliphatic diols, and bisphenol A and other such aromatic diols. Moreover, a polyester elastomer containing ε-caprolactone or tetramethylene glycol or the like may be contained as a component constituting the polyester. Regarding the polyester raw materials cited above, a plurality of types of homopolyesters obtained by polymerizing one type of carboxylic acid monomer and one type of diol monomer may be mixed and used (dry blended); and two or more types of carboxylic acid monomers or two or more types of diol monomers may be copolymerized and used. A homopolyester and a copolymerized polyester may be mixed and used.

The intrinsic viscosity (IV) of the polyester serving as a raw material is not particularly limited, and can be optionally selected, but the intrinsic viscosity is preferably 0.5 dL/g to 1.2 dL/g. When IV is less than 0.5 dL/g, the molecular weight of the raw material is too low, which increases the tendency for fracture to occur during film formation, and increases the tendency for the tensile fracture strength of a display body to fall below 40 MPa, and for other such problems to occur. Meanwhile, when IV exceeds 1.2 dL/g, the resin pressure at the time of an extruding process during film formation is too high. This is apt to cause the deformation of the filter and the like, which is not preferred. IV is more preferably 0.55 dL/g or more and 1.15 dL/g or less, and still more preferably 0.6 dL/g or more and 1.1 dL/g or less.

Examples of the polyolefin include polypropylene (PP) and polyethylene (PE). In a case where the polypropylene is used, the stereoregularity thereof is not particularly limited, and the polypropylene may isotactic, syndiotactic, or atactic polypropylene. Each of the polypropylenes may be contained in any percentage. In a case where the polyethylene is used, the density (degree of branching) thereof is not particularly limited, and the polyethylene may be high density (HDPE), linear low density (LLDPE), or low density (LDPE) polyethylene. Besides the foregoing homopolymers, raw materials in which two or more different types of monomers are copolymerized may be used. Examples of the monomers used for copolymerization include ethylene and α-olefins, and examples of the α-olefins include propylene, 1-butene, 1-pentene, 1-hexene, 1-heptene, 1-octene, 1-nonene, 1-decene, 4-methyl-1-pentene, and 4-methyl-1-hexene. The type of the copolymerization may be random copolymerization or block copolymerization. Moreover, besides the raw materials cited above, a polyolefin elastomer and an ionomer may be used.

The melt flow rate (MFR) of the polyolefin serving as the raw material is not particularly limited, and can be optionally selected, but the melt flow rate is preferably 1 g/10 min to 10 g/10 min. When the MFR is less than 1 g/10 min, the melt viscosity of the raw material is too high, and the resin pressure at the time of an extruding process during film formation is too high. This is apt to cause the deformation and the like of the filter, which is not preferred. Meanwhile, when the MFR exceeds 10 g/10 min, the molecular weight is extremely low, and therefore there is a possibility that fracture is apt to occur during film formation, and that blocking resistance is reduced. The MFR is more preferably 2 g/10 min or more and 8 g/10 min, and still more preferably 3 g/10 min or more and 7 g/10 min.

Examples of the polystyrene include homopolystyrene obtained by polymerizing only a styrene monomer, and a polymer obtained by copolymerizing different components therein. In a case where the homopolystyrene is used, the stereoregularity thereof is not particularly limited, and the homopolystyrene may isotactic, syndiotactic, or atactic homopolystyrene. Each of the homopolystyrenes may be contained in any percentage. In the case of a copolymer, any component may be used without departing from the gist of the present invention. Examples thereof include butadiene, isoprene, propylene, ethylene, acrylonitrile, and vinyl acetate, and these can be copolymerized in any ratio. A polystyrene-based elastomer may be used, and examples thereof include polymers obtained by block-copolymerizing an aromatic alkenyl compound and a conjugated diene. Examples of the aromatic alkenyl compound include styrene, tert-butylstyrene, α-methylstyrene, p-methylstyrene, p-ethylstyrene, divinylbenzene, 1,1-diphenylethylene, vinylnaphthalene, vinylanthracene, N,N-dimethyl-p-aminoethylstyrene, N,N-diethyl-p-aminoethylstyrene, and vinylpyridine. Examples of the conjugated diene monomer include 1,3-butadiene, 1,2-butadiene, isoprene, 2,3-dimethyl-butadiene, 1,3-pentadiene, 2-methyl-1,3-butadiene, 2-methyl-1,3-pentadiene, 1,3-hexadiene, 1,3-cyclohexadiene, 4,5-diethyl-1,3-octadiene, 3-butyl-1,3-octadiene, myrcene, chloroprene, and other such diolefins.

Examples of the polyamide include any one type of resin or a raw material mixture of two or more types of resins selected from polycaproamide (nylon 6), polyhexamethylene adipamide (nylon 66), caprolactam/lauryl lactam copolymer (nylon 6/12), caprolactam/hexamethylene diammonium adipate copolymer (nylon 6/66), ethylene ammonium adipate/hexamethylene diammonium adipate/hexamethylene diammonium sebacate copolymer (nylon 6/66/610), polymers of meta-xylylenediamine and adipic acid (MXD-6), and hexamethylene isophthalamide/terephthalamide copolymer (amorphous nylon). An adhesion improvement layer may be provided on the surface of the film containing any of the plastics cited above. Example of a material for the adhesion improvement layer include acrylic, a water-soluble or water-dispersible polyester, and a hydrophobic polyester in which acrylic is graft copolymerized.

It is preferred that the relative viscosity (RV) of the polyamide serving as the raw material is 2.2 or more and 4 or less. When the RV is less than 2.2, the crystallization rate is too high, and therefore the fracture or the like of the film may be apt to occur when stretching is carried out during film forming processes. Meanwhile, when the RV exceeds 4, a load on an extruder is too high, and therefore the deformation and the like of the filter is apt to occur, which is not preferred. The RV is more preferably 2.3 or more and 3.9 or less, and still more preferably 2.4 or more and 3.8 or less. The “relative viscosity” in the present invention means a value measured at 25° C. using a solution in which 0.5 g of a polymer is dissolved in 50 ml of 97.5% sulfuric acid.

It is preferred that the type of the plastic constituting the laser-printed layer is mainly any of polyester, polypropylene, polyethylene, and polystyrene among those cited above from the viewpoint of mechanical strength, film forming stability, and laser printing performance.

The content of the plastic constituting the laser-printed layer is preferably 50% by mass or more and 99.95% by mass or less. When the content of the plastic falls below 50% by mass, tensile fracture strength to be described later may be apt to fall below 40 MPa, which is not preferred. When the content of the plastic exceeds 99.95% by mass, the content of the laser-printed pigment relatively falls below 0.05% by mass, and the difference between the color L* values of the printed portion and the non-printed portion is apt to fall below 1.0, which is not preferred. The content of the plastic is more preferably 51% by mass or more and 99.9% by mass or less, still more preferably 52% by mass or more and 99.85% by mass, and particularly preferably 53% by mass or more and 99.8% by mass or less. In a case where a plurality of laser-printed layers are present, the content of the plastic in all the laser-printed layers can be determined by proportionally dividing the thickness ratios and plastic contents of the respective layers.

1.2.3. Additives Other than Laser-Printed Pigment

Various additives, e.g., waxes, antioxidants, anti-static agents, crystal nucleating agents, viscosity-lowering agents, thermal stabilizers, colorant pigments, antistaining agents, and ultraviolet light absorbers and the like may be added as necessary in the laser-printed layer constituting the in-mold label of the present invention. In a case where the laser-printed layer is a surfacemost layer, it is preferred that microparticles serving as a lubricant for improving lubricity is added thereto. The microparticles may be optionally selected. Examples of inorganic microparticles include silica, alumina, kaolin, white lead, titanium white, zeolite, zinc oxide, and lithopone, and examples of organic microparticles include acrylic particles, melamine particles, silicone particles, crosslinked polystyrene particles, carbon black, and iron oxide. The average particle diameter of the microparticles when measured by means of a Coulter counter may be appropriately selected as necessary within the range 0.05 μm to 3.0 μm. The lower limit of the content rate of the microparticles is preferably 0.01% by mass, more preferably 0.015% by mass, and still more preferably 0.02% by mass. When the content rate of the microparticles is less than 0.01% by mass, lubricity may be reduced. The upper limit of the content rate of the microparticles is preferably 1% by mass, more preferably 0.2% by mass, and still more preferably 0.1% by mass. When the content rate of the microparticles exceeds 1% by mass, the smoothness of the surface may be reduced to cause problems such as faint printability, which is not preferred.

As a method for blending particles within the laser-printed layer, the particles may be added in any step during the manufacture of the plastic raw material, and the same method as that of the foregoing “1.2.1. Types of laser-printed pigments, amounts thereof added, and methods for adding same” can be adopted.

### 1.3. Heat Seal Layer

The heat seal layer that can constitute the in-mold label of the present invention is not particularly limited as long as the heat seal layer has adhesiveness, and conventionally known heat seal layers can be optionally used without departing from the gist of the present invention. Examples thereof include a heat seal layer that exerts adhesiveness by heat and a pressure sensitive adhesive (tacky) layer that has adhesiveness at room temperature. The heat seal layer may be formed by the coating of a laminating agent as mentioned in “1.4. Laminating agent” to be described later.

Examples of the type of the plastic constituting the heat seal layer include polyester, polyurethane, acrylic, polyolefin, and polyamide.

Examples of the polyester include polyethylene terephthalate (PET), polybutylene terephthalate (PBT), polyethylene naphthalate (PEN), polytrimethylene terephthalate (PTT), polybutylene naphthalate (PBN), polylactic acid (PLA), polyethylene furanoate (PEF), and polybutylene succinate (PBS). Moreover, in addition to the polyesters cited at the foregoing examples, modified polyesters in which the monomer at such acid site or diol site is altered may also be used. Examples of the acid-site monomer include isophthalic acid, 1,4-cyclohexanedicarboxylic acid, 2,6-naphthalenedicarboxylic acid, orthophthalic acid, and other such aromatic dicarboxylic acids, adipic acid, azelaic acid, sebacic acid, decanedicarboxylic acid, and other such aliphatic dicarboxylic acids, and alicyclic dicarboxylic acids. Examples of the diol-site monomer include neopentyl glycol, 1,4-cyclohexanedimethanol, diethylene glycol, 2,2-diethyl-1,3-propanediol, 2-n-butyl-2-ethyl-1,3-propanediol, 2,2-isopropyl-1,3-propanediol, 2,2-di-n-butyl-1,3-propanediol, hexanediol, 1,4-butanediol, and other such long-chain diols, hexanediol and other such aliphatic diols, and bisphenol A and other such aromatic diols. Moreover, a polyester elastomer containing ε-caprolactone or tetramethylene glycol or the like may be contained as a component constituting the polyester. Regarding the polyester raw materials cited above, a plurality of types of homopolyesters obtained by polymerizing one type of carboxylic acid monomer and one type of diol monomer may be mixed and used (dry blended); and two or more types of carboxylic acid monomers or two or more types of diol monomers may be copolymerized and used. A homopolyester and a copolymerized polyester may be mixed and used.

Examples of the polyolefin include polypropylene (PP) and polyethylene (PE). In a case where the polypropylene is used, the stereoregularity thereof is not particularly limited, and the polypropylene may isotactic, syndiotactic, or atactic polypropylene. Each of the polypropylenes may be contained in any percentage. In a case where the polyethylene is used, the density (degree of branching) thereof is not particularly limited, and the polyethylene may be high density (HDPE), linear low density (LLDPE), or low density (LDPE) polyethylene. Besides the foregoing homopolymers, raw materials in which two or more different types of monomers are copolymerized may be used. Examples of the monomers used for copolymerization include ethylene and α-olefins, and examples of the α-olefins include propylene, 1-butene, 1-pentene, 1-hexene, 1-heptene, 1-octene, 1-nonene, 1-decene, 4-methyl-1-pentene, and 4-methyl-1-hexene. The type of the copolymerization may be random copolymerization or block copolymerization. Moreover, besides the raw materials cited above, a polyolefin elastomer and an ionomer may be used.

The melt flow rate (MFR) of the polyolefin serving as the raw material is not particularly limited, and can be optionally selected, but the melt flow rate is preferably 1 g/10 min to 10 g/10 min. When the MFR is less than 1 g/10 min, the melt viscosity of the raw material is too high, and the resin pressure at the time of an extruding process during film formation is too high. This is apt to cause the deformation and the like of the filter, which is not preferred. Meanwhile, when the MFR exceeds 10 g/10 min, the molecular weight is extremely low, and therefore there is a possibility that fracture is apt to occur during film formation, and that blocking resistance is reduced. The MFR is more preferably 2 g/10 min or more and 8 g/10 min, and still more preferably 3 g/10 min or more and 7 g/10 min.

Examples of the polyamide include any one type of resin or a raw material mixture of two or more types of resins selected from polycaproamide (nylon 6), polyhexamethylene adipamide (nylon 66), caprolactam/lauryl lactam copolymer (nylon 6/12), caprolactam/hexamethylene diammonium adipate copolymer (nylon 6/66), ethylene ammonium adipate/hexamethylene diammonium adipate/hexamethylene diammonium sebacate copolymer (nylon 6/66/610), polymers of meta-xylylenediamine and adipic acid (MXD-6), and hexamethylene isophthalamide/terephthalamide copolymer (amorphous nylon). An adhesion improvement layer may be provided on the surface of the film containing any of the plastics cited above. Example of a material for the adhesion improvement layer include acrylic, a water-soluble or water-dispersible polyester, and a hydrophobic polyester in which acrylic is graft copolymerized.

The lower limit of the relative viscosity (RV) of polyamide serving as the raw material is preferably 2.2, and more preferably 2.3. When the RV is less than the above, a crystallization rate is too high, which may result in difficult biaxial stretching. Meanwhile, the upper limit of the RV of polyamide is preferably 4, and more preferably 3.9. When the RV exceeds the above, there is a possibility that a load or the like on an extruder is too high, resulting in a decrease in productivity. The “relative viscosity” in the present invention means a value measured at 25° C. using a solution in which 0.5 g of a polymer is dissolved in 50 ml of 97.5% sulfuric acid.

Examples of the type of the plastic constituting the pressure sensitive adhesive layer include polyester, polyolefin, polystyrene, and acryl, and those having a glass transition temperature Tg which falls below room temperature (in the vicinity of 25° C.) are particularly preferred.

As an example of the polyester, as a monomer that permits Tg to be lowered, a saturated carboxyl acid component or a saturated diol component is preferably used. Examples of saturated carboxyl acid include adipic acid, azelaic acid, sebacic acid, decanedicarboxylic acid, and 1,4-cyclohexanedicarboxylic acid. Among these, adipic acid and azelaic acid are preferred. Examples of the saturated diol component include ethylene glycol, diethylene glycol, 1,3-propanediol, 2,2-diethyl-1,3-propanediol, 1,4-butanediol, and other such long-chain diols, and hexanediol and other such aliphatic diols. Among these, use of diethylene glycol, 1,3-propanediol, and 1,4-butanediol is preferred. Moreover, as a component constituting a polyester-based resin, a polyester elastomer containing F-caprolactone or tetramethylene glycol or the like may be used. The polyester elastomer may be favorably used since the polyester elastomer is effective in lowering Tg.

Examples of the polyolefin-based substance include polyolefin-based elastomers. Examples of the polyolefin-based elastomers include ethylene-propylene copolymer, ethylene-1-butene copolymer, ethylene-1-hexene copolymer, ethylene-1-octene copolymer, ethylene-4-methyl-1-pentene copolymer, ethylene-propylene-1-butene copolymer, ethylene-propylene-1-hexene copolymer, ethylene-1-butene-1-hexene copolymer, propylene-1-butene copolymer, propylene-1-hexene copolymer, propylene-1-octene copolymer, propylene-4-methyl-1-pentene copolymer, propylene-1-butene-1-hexene copolymer, and propylene-1-butene-4-methyl-1-pentene copolymer. A small amount of SBS, SEBS, and other such styrenic elastomers may be added thereto.

Examples of the polystyrene include polystyrenic elastomers. Examples of the polystyrenic elastomers include polymers in which an aromatic alkenyl compound and a conjugated diene are block copolymerized; examples of the aromatic alkenyl compound include styrene, tert-butylstyrene, α-methylstyrene, p-methylstyrene, p-ethylstyrene, divinylbenzene, 1,1-diphenylethylene, vinylnaphthalene, vinylanthracene, N,N-dimethyl-p-aminoethylstyrene, N,N-diethyl-p-aminoethylstyrene, and vinylpyridine; and examples of the conjugated diene monomer include 1,3-butadiene, 1,2-butadiene, isoprene, 2,3-dimethyl-butadiene, 1,3-pentadiene, 2-methyl-1,3-butadiene, 2-methyl-1,3-pentadiene, 1,3-hexadiene, 1,3-cyclohexadiene, 4,5-diethyl-1,3-octadiene, 3-butyl-1,3-octadiene, myrcene, chloroprene, and other such diolefins.

The acryl may be a copolymer of an acrylic monomer or a copolymer of an acrylic monomer and a monomer other than the acrylic monomer which is capable of being copolymerized. As the acrylic monomer include, for example, (meth)acrylate, methyl (meth)acrylate, ethyl (meth)acrylate, propyl (meth)acrylate, isopropyl acrylate, n-butyl (meth)acrylate, isobutyl acrylate, t-butyl (meth)acrylate, n-amyl (meth)acrylate, isoamyl (meth)acrylate, n-hexyl (meth)acrylate, 2-ethylhexyl. (meth)acrylate, n-octyl (meth)acrylate, decyl (meth)acrylate, octadecyl (meth)acrylate, lauryl (meth)acrylate, stearyl (meth)acrylate, and other such (meth)acrylic acid alkyl esters; cyclohexyl (meth)acrylate, benzyl (meth)acrylate, phenyl (meth)acrylate, and other such (meth)acrylic acid cyclic esters; allyl (meth)acrylate, 1-methylallyl (meth)acrylate, 2-methylallyl (meth)acrylate, and other such vinyl (meth)acrylates and other such unsaturated-group-containing (meth)acrylic acid esters; glycidyl (meth)acrylate, (3,4-epoxycyclohexyl)methyl (meth)acrylate, and other such heterocycle-containing (meth)acrylic acid esters; N-methylaminoethyl (meth)acrylate, N-tributylaminoethyl (meth)acrylate, N,N-dimethylaminoethyl (meth)acrylate, and other such amino-group containing (meth)acrylic acid esters; 3-methacryloxypropyltrimethoxysilane and other such alkoxysilyl-group-containing (meth)acrylic acid esters; methoxyethyl (meth)acrylate, ethylene oxide adduct of (meth)acrylic acid, and other such (meth)acrylic acid derivatives; perfluoroethyl (meth)acrylate, perfluorobutyl (meth)acrylate, and other such (meth)acrylic acid perfluoroalkyl esters; trimethylolpropane tri(meth)acrylate and other such polyfunctional (meth)acrylic acid esters. Examples of the monomers other than acrylic monomers that are capable of being copolymerized include maleic acid, maleic anhydride, itaconic acid, and itaconic anhydride as monomers having at least one carboxyl group at a radical polymerizable unsaturated group. Besides the radical polymerizable unsaturated groups, examples of monomers having at least one hydroxyl group include 2-hydroxyethyl (meth)acrylate, 2-hydroxypropyl (meth)acrylate, 2-hydroxybutyl (meth)acrylate, and diethylene glycol mono(meth)acrylate. Moreover, examples of vinyl monomers and the like which are capable of being copolymerized with the acrylic monomer include styrene, α-styrene, and other such aromatic vinyl-based monomers; vinyltrimethoxysilane and other such trialkyloxysilyl-group-containing vinyl monomers; acrylonitrile, methacrylonitrile, and other such nitrile-group-containing vinyl-based monomers; acrylamide- and methacrylamide-group-containing vinyl-based monomers; vinyl acetate, vinyl versatate, and other such vinyl esters.

The plastic of any of the types described above as a raw material may be optionally used as a film formed so as to be unstretched, uniaxially stretched, or biaxially stretched, or as a coating agent in which the plastic is dispersed in a solvent or the like. In a case where a film is formed, the film is preferably unstretched or uniaxially stretched, and more preferably unstretched for achievement of sealing properties. In this case, the laser-printed layer and the heat seal layer may be laminated with an adhesive layer to be described later therebetween, or the heat seal layer may be laminated in an extrusion process when the laser-printed layer is formed.

The thickness of the heat seal layer constituting the in-mold label of the present invention is preferably 1 μm or more and 50 μm or less. When the thickness of the heat seal layer falls below 1 μm, the bonding strength between the in-mold label and the container is lowered, which is not preferred. When the thickness of the heat seal layer exceeds 50 μm, the bonding strength between the in-mold label and the container is improved, but the thickness of the laser-printed layer is relatively reduced, and the visual perceptibility of printing is diminished, which is not preferred. The thickness of the heat seal layer is more preferably 1.5 μm or more and 40 μm or less, and still more preferably 2 μm or more and 30 μm or less.

### 1.4. Laminating Agent

As a laminating agent that can be used when each layer of the in-mold label of the present invention is laminated, an adhesive for dry lamination or a resin layer formed by extrusion lamination can be used, and conventionally known ones can be optionally employed. The adhesive may be either a one liquid type (drying type) or a two liquid type (curing reaction type). In the case of dry lamination, commercially available polyurethane-based and polyester-based adhesives for dry lamination can be used. Representative examples include Dicdry (registered trademark) LX-703VL manufactured by DIC Corporation; KR-90 manufactured by DIC Corporation; Takenate (registered trademark) A-4 manufactured by Mitsui Chemicals, Inc.; and Takelac (registered trademark) A-905 manufactured by Mitsui Chemicals, Inc. In the case of the extrusion lamination, a polyolefin-based resin such as polyethylene is melted between layers or between a layer and another layer for bonding, but it is also preferred to laminate an anchor coat layer in order to enhance the adhesiveness of the surface of the layer and the like.

In a case of laminating films with a laminating agent interposed therebetween, the lamination is completed as the laminating agent is applied to either film, and then dried or reacted and cured. In the in-mold label of the present invention, the lamination layer thickness after drying is preferably 1 μm or more and 6 μm or less, and more preferably 2 μm or more and 5 μm or less. When the thickness of the lamination layer after drying falls below 1 μm, delamination is apt to occur, which is not preferred. Meanwhile, when the lamination layer thickness after drying exceeds 6 μm, a drying time required for curing the laminating agent is long, resulting a decrease in the productivity of the in-mold label, which is not preferred.

### 1.5. Substrate Layer

Examples of the type of the plastic constituting the substrate layer that can be preferably included in the in-mold label of the present invention include polyester, polyolefin, and polyamide.

Examples of the polyester include polyethylene terephthalate (PET), polybutylene terephthalate (PBT), polyethylene naphthalate (PEN), polytrimethylene terephthalate (PTT), polybutylene naphthalate (PBN), polylactic acid (PLA), polyethylene furanoate (PEF), and polybutylene succinate (PBS). Moreover, in addition to the polyesters cited at the foregoing examples, modified polyesters in which the monomer at such acid site or diol site is altered may also be used. Examples of the acid-site monomer include isophthalic acid, 1,4-cyclohexanedicarboxylic acid, 2,6-naphthalenedicarboxylic acid, orthophthalic acid, and other such aromatic dicarboxylic acids, adipic acid, azelaic acid, sebacic acid, decanedicarboxylic acid, and other such aliphatic dicarboxylic acids, and alicyclic dicarboxylic acids. Examples of the diol-site monomer include neopentyl glycol, 1,4-cyclohexanedimethanol, diethylene glycol, 2,2-diethyl-1,3-propanediol, 2-n-butyl-2-ethyl-1,3-propanediol, 2,2-isopropyl-1,3-propanediol, 2,2-di-n-butyl-1,3-propanediol, hexanediol, 1,4-butanediol, and other such long-chain diols, hexanediol and other such aliphatic diols, and bisphenol A and other such aromatic diols. Moreover, a polyester elastomer containing ε-caprolactone or tetramethylene glycol or the like may be contained as a component constituting the polyester. Regarding the polyester raw materials cited above, a plurality of types of homopolyesters obtained by polymerizing one type of carboxylic acid monomer and one type of diol monomer may be mixed and used (dry blended); and two or more types of carboxylic acid monomers or two or more types of diol monomers may be copolymerized and used. A homopolyester and a copolymerized polyester may be mixed and used.

Examples of the polyolefin include polypropylene (PP) and polyethylene (PE). In a case where the polypropylene is used, the stereoregularity thereof is not particularly limited, and the polypropylene may isotactic, syndiotactic, or atactic polypropylene. Each of the polypropylenes may be contained in any percentage. In a case where the polyethylene is used, the density (degree of branching) thereof is not particularly limited, and the polyethylene may be high density (HDPE), linear low density (LLDPE), or low density (LDPE) polyethylene. Besides the foregoing homopolymers, raw materials in which two or more different types of monomers are copolymerized may be used. Examples of the monomers used for copolymerization include ethylene and α-olefins, and examples of the α-olefins include propylene, 1-butene, 1-pentene, 1-hexene, 1-heptene, 1-octene, 1-nonene, 1-decene, 4-methyl-1-pentene, and 4-methyl-1-hexene. The type of the copolymerization may be random copolymerization or block copolymerization. Moreover, besides the raw materials cited above, a polyolefin elastomer and an ionomer may be used.

The melt flow rate (MFR) of the polyolefin serving as the raw material is not particularly limited, and can be optionally selected, but the melt flow rate is preferably 1 g/10 min to 10 g/10 min. When the MFR is less than 1 g/10 min, the melt viscosity of the raw material is too high, and the resin pressure at the time of an extruding process during film formation is too high. This is apt to cause the deformation and the like of the filter, which is not preferred. Meanwhile, when the MFR exceeds 10 g/10 min, the molecular weight is extremely low, and therefore there is a possibility that fracture is apt to occur during film formation, and that blocking resistance is reduced. The MFR is more preferably 2 g/10 min or more and 8 g/10 min, and still more preferably 3 g/10 min or more and 7 g/10 min.

Examples of the polyamide include any one type of resin or a raw material mixture of two or more types of resins selected from polycaproamide (nylon 6), polyhexamethylene adipamide (nylon 66), caprolactam/lauryl lactam copolymer (nylon 6/12), caprolactam/hexamethylene diammonium adipate copolymer (nylon 6/66), ethylene ammonium adipate/hexamethylene diammonium adipate/hexamethylene diammonium sebacate copolymer (nylon 6/66/610), polymers of meta-xylylenediamine and adipic acid (MXD-6), and hexamethylene isophthalamide/terephthalamide copolymer (amorphous nylon). An adhesion improvement layer may be provided on the surface of the film containing any of the plastics cited above. Example of a material for the adhesion improvement layer include acrylic, a water-soluble or water-dispersible polyester, and a hydrophobic polyester in which acrylic is graft copolymerized.

The lower limit of the relative viscosity (RV) of polyamide serving as the raw material is preferably 2.2, and more preferably 2.3. When the RV is less than the above, a crystallization rate is too high, which may result in difficult biaxial stretching. Meanwhile, the upper limit of the RV of polyamide is preferably 4, and more preferably 3.9. When the RV exceeds the above, there is a possibility that a load or the like on an extruder is too high, resulting in a decrease in productivity. The “relative viscosity” in the present invention means a value measured at 25° C. using a solution in which 0.5 g of a polymer is dissolved in 50 ml of 97.5% sulfuric acid.

The plastic of any of the types described above as a raw material may be optionally used as a film formed so as to be unstretched, uniaxially stretched, or biaxially stretched, or as a coating agent in which the plastic is dispersed in a solvent or the like. In a case of forming a film, the film is preferably uniaxially stretched or biaxially stretched, and more preferably biaxially stretched for achievement of mechanical strength. In this case, the printed layer and the substrate layer may be laminated with an adhesive layer to be described later interposed therebetween, or the substrate layer may be laminated during the extrusion process when the printed layer is formed.

The substrate layer preferably contains a lubricant in order to improve the lubricity, and the concentration thereof contained is preferably 100 ppm or more and 2000 ppm or less. When the concentration of the lubricant fall below 100 ppm, the lubricity deteriorates, and thus not only position shift and the like occurs when a laminated body is fabricated (bonded) but also the handling properties decrease when the laminated body is formed, which is not preferred. Meanwhile, the concentration of the lubricant exceeds 2000 ppm, the transparency of the substrate layer decreases, which is not preferred. The concentration of the lubricant is more preferably 200 ppm or more and 1900 ppm or less, and still more preferably 300 ppm or more and 1800 ppm or less.

To cause the printing properties and lubricity of the surface of the substrate layer to be made satisfactory, a layer subjected to corona treatment, coating treatment, and flame treatment and the like can also be provided on the substrate layer, and the layer can be optionally provided without departing from the requirements of the present invention.

### 1.6. Other Layers

The in-mold label of the present invention may include a layer other than the laser-printed layer and heat seal layer described above. Hereinafter, a gas barrier layer (transparent, opaque) and a printed layer will be described.

### 1.6.1. Gas Barrier Layer

The gas barrier layer that can be optionally laminated on the in-mold label of the present invention is preferably composed of an inorganic thin film containing a metal or a metal oxide as a main component. In addition to the gas barrier layer composed of the inorganic thin film, the gas barrier layer may further include an anchor coat layer provided under the inorganic thin film layer (between the plastic film and the inorganic thin film) and an overcoat layer provided above the inorganic thin film layer. By providing these layers, improvement in close contact properties to the gas barrier layer, and improvement in gas barrier properties, and the like can be expected.

The type of a raw material for the gas barrier layer is not particularly limited, and conventionally known materials can be used, and the raw material can be appropriately selected according to the purpose in order to satisfy the desired gas barrier properties and the like. Examples of the type of the raw material for the gas barrier layer include metals such as silicon, aluminum, tin, zinc, iron, and manganese, and inorganic compounds containing one or more of these metals, and examples of the inorganic compounds include oxides, nitrides, carbides, and fluorides. These inorganic substances or inorganic compounds may be used singly or in combination.

In a case where the gas barrier layer is transparent, silicon oxide (SiOx) and aluminum oxide (AlOx) can be used singly (simple substances) or in combination (binary substances). In a case where the component of the inorganic compound consists of a binary substance of silicon oxide and aluminum oxide, the content of the aluminum oxide is preferably 20% by mass or more and 80% by mass or less, and more preferably 25% by mass or more and 70% by mass or less. In a case where the content of the aluminum oxide is 20% by mass or less, the density of the gas barrier layer may decrease, resulting in a decrease in the gas barrier properties, which is not preferred. When the content of the aluminum oxide is 80% by mass or more, the flexibility of the gas barrier layer decreases, which is apt to cause cracking to occur. As a result, the gas barrier properties may decrease, which is not preferred.

When an oxygen/metal element ratio in the metal oxide used for the gas barrier layer is preferably 1.3 or more and less than 1.8, there is little variation in gas barrier properties and excellent gas barrier properties can always be acquired, which is preferred. The oxygen/metal element ratio can be determined by measuring the amounts of the respective elements of oxygen and metal by X-ray photoelectron spectroscopy (XPS) and calculating the oxygen/metal element ratio.

The thickness of the gas barrier layer that can be preferably used in the in-mold label of the present invention is preferably 2 nm or more and 100 nm or less in a case where a metal or a metal oxide is vapor-deposited and used as a gas barrier layer. When the thickness of the layer falls below 2 nm, the gas barrier properties are apt to decrease, which is not preferred. Meanwhile, when the thickness of the layer exceeds 100 nm, there is no corresponding effect of improving the gas barrier properties, and the manufacturing cost increases, which is not preferred. The thickness of the inorganic thin film layer is more preferably 5 nm or more and 97 nm or less, and still more preferably 8 nm or more and 94 nm or less.

In a case where a metal foil is used as the gas barrier layer, the thickness of the metal foil is preferably 3 μm or more and 100 μm or less. When the thickness of the layer falls below 3 μm, the gas barrier properties are apt to decrease, which is not preferred. Meanwhile, when the thickness of the layer exceeds 100 nm, there is no corresponding effect of improving the gas barrier properties, and the manufacturing cost increases, which is not preferred. The thickness of the inorganic thin film layer (metal foil) is more preferably 5 μm or more and 97 μm or less, and still more preferably 8 μm or more and 94 μm or less.

In a case where the gas barrier layer is opaque, the gas barrier layer can be formed by bonding an aluminum foil or vapor-depositing aluminum. The thickness of the aluminum foil is preferably 1 μm or more and 100 μm or less.

The in-mold label including the gas barrier layer thus provided preferably has a water vapor transmission rate of 0.05 [g/(m²·d)] or more and 4 [g/(m²·d)] or less in an environment having a temperature of 40° C. and a relative humidity of 90% RH. When the water vapor transmission rate exceeds 4 [g/(m²·d)], the shelf life of contents is shortened in a case where an in-mold label containing the contents is used, which is not preferred. Meanwhile, the water vapor transmission rate is less than 0.05 [g/(m²·d)], the gas barrier properties are enhanced and the shelf life of the contents is extended, which is preferred, but the lower limit of the water vapor transmission rate is 0.05 [g/(m²·d)] in the current technical level. When the lower limit of the water vapor transmission rate is 0.05 [g/(m²·d)], it can be said that the water vapor transmission rate is practically adequate. The upper limit of the water vapor transmission rate is preferably 3.8 [g/(m²·d)], and more preferably 3.6 [g/(m²·d)].

The in-mold label including the gas barrier layer preferably has an oxygen transmission rate of 0.05 [cc/(m²·d·atm)] or more and 4 [cc/(m²·d·atm)] or less in an environment having a temperature of 23° C. and a relative humidity of 65% RH. When the oxygen transmission rate exceeds 4 [cc/(m²·d·atm)], the shelf life of the contents is shortened, which is not preferred. Meanwhile, in a case where the oxygen transmission rate is less than 0.05 [cc/(m²·d·atm)], the gas barrier properties are enhanced and the shelf life of the contents is extended, which is preferred, but the lower limit of the oxygen transmission rate is 0.05 [cc/(m²·d·atm)] in the current technical level. When the lower limit of the oxygen transmission rate is 0.05 [cc/(m²·d·atm)], it can be said that the oxygen transmission rate is practically adequate. The upper limit of the oxygen transmission rate is preferably 3.8 [cc/(m²·d·atm)], and more preferably 3.6 [cc/(m²·d·atm)].

In the gas barrier in-mold label using the in-mold label of the present invention (in this section, these are collectively referred to as an “in-mold label”), the gas barrier layer may be laminated, followed by providing an overcoat layer on the gas barrier layer for the purpose of improving scratch resistance and further improving gas barrier properties, and the like.

The type of the overcoat layer is not particularly limited, but conventionally known materials, such as compositions containing urethane-based resins and silane coupling agents, compounds containing organosilicon and hydrolysates thereof, and water-soluble polymers having hydroxyl or carboxyl groups, can be used, and the materials can be appropriately selected according to the purpose in order to satisfy the desired gas barrier properties and the like.

For the purpose of imparting antistatic properties, ultraviolet absorbency, coloring, thermal stability, and lubricity and the like, one or more of various additives may be added to the overcoat layer as long as the object of the present invention is not impaired, and the types and amounts of the various additives can be appropriately selected according to the desired purpose.

### 1.6.2. Printed Layer

In addition to printing by laser irradiation, the in-mold label of the present invention may be provided with characters and patterns for the purpose of improving designability. As materials for forming these characters and patterns, known materials such as ink for gravure printing and ink for flexographic printing can be used. Regarding the number of printed layers, there may be one such layer or there may be a plurality of such layers. So as to be able to improve designability by printing a plurality of colors, it is preferred that there is a printed layer that includes a plurality of layers. The printed layer may be positioned either at an outermost layer or an intermediate layer.

### 2. Properties of In-Mold Label

### 2.1. Difference Between Color L* Values (Non-Printed Portion-Printed Portion)

In the in-mold label of the present invention, it is required that the absolute value of the difference between the color L* values of the printed portion and the non-printed portion (hereinafter sometimes referred to simply as a “difference between L* values”) is 1.0 or more and 10.0 or less. When this difference is less than 1.0, the color tones of the printed portion and non-printed portion are close to each other, which makes it difficult to visually recognize the printing. Meanwhile, when the difference between the L* values exceeds 10.0, the printing is likely to be visually recognized, but it is necessary to increase the power of laser irradiation accordingly. This causes not only problems such as perforation being apt to occur due to increased damage to the in-mold label, but also a decreased display area due to a relatively increased printed size, which is not preferred. The difference between the L* values is more preferably 1.5 or more and 9.5 or less, and still more preferably 2.0 or more and 9.0 or less.

2.2. Bonding Strength with Container

The in-mold label of the present invention preferably has bonding strength with a container of 2 N/15 mm or more and 20 N/15 mm or less. When the bonding strength with the container is less than 2 N/15 mm, the bonded portion is easily peeled off, which is not preferred. The bonding strength is more preferably 3 N/15 mm or more, and still more preferably 4 N/15 mm or more. As the bonding strength is higher, the peeling of the in-mold label from the container is less likely to occur, which is preferred, but the upper limit of the bonding strength to be currently obtained is about 20 N/15 mm. When the upper limit of the bonding strength with the container is 10 N/15 mm, the bonding strength can be said to be adequately preferred for practical use.

### 2.3. Size of Printing

With regard to the size of printing formed on the in-mold label of the present invention by laser, either a height or a width is preferably 0.2 mm or more and 100 mm or less. As it is said that the resolving power of the human eye is on the order of 0.2 mm, and when the size of a character falls below 0.2 mm, the difference between color L* values is apt to be less than 1.0, making recognition of printing difficult. Meanwhile, when the size of printing exceeds 100 mm, the printing is easily recognized, which is preferred, but when the size of printing is too large, the amount of information described on the in-mold label is small, which is not preferred. The size of printing is more preferably 0.5 mm or more and 90 mm or less, still more preferably 1 mm or more and 80 mm or less, and particularly preferably 1.5 mm or more and 70 mm or less.

### 2.4. Tensile Fracture Strength

In the in-mold label of the present invention, the tensile fracture strength measured in at least any one direction on the plane of the in-mold label is preferably 40 MPa or more and 400 MPa. When the tensile fracture strength falls below 40 MPa, the in-mold label easily fractures under external tension, which is not preferred. The lower limit of the tensile fracture strength is more preferably 50 MPa, and still more preferably 60 MPa. Meanwhile, tensile fracture strength that exceeds 400 MPa is preferred in terms of mechanical strength, but the upper limit of the tensile rupture strength is 400 MPa in the technical level of the present invention. Even when the tensile fracture strength is 300 MPa, the tensile fracture strength is practically adequate.

### 3. Manufacturing Conditions

### 3.1. Plastic Film Layer (Laser-Printed Layer, Seal Layer, Other Layers)

The laser-printed layer, seal layer, and other layers that constitute the in-mold label of the present invention can be manufactured by methods and conditions to be described below. In the following, the methods and the conditions will be described mainly taking the laser-printed layer as an example.

### 3.1.1. Mixing and Supply of Raw Materials

In manufacturing the laser-printed layer included in the in-mold label of the present invention, it is necessary to add the laser-printed pigment described in the above “1.2.1. Types of laser-printed pigments, amounts thereof added, and methods for adding same”.

The laser-printed pigment is a metal, and thus usually has a higher specific gravity than that of the resin constituting the film. When two or more types of raw materials having different specific gravities are mixed and fed to an extruder, variation (segregation) is apt to occur in the supply of the raw materials. To prevent such variation, it is preferred that an agitator is installed at a hopper and a plumbing immediately above the extruder, that a plumbing (inner piping) is inserted within a hopper immediately above the extruder filled with a base resin to supply a laser-printed pigment, that tapered collars for lowering the granular pressure of raw materials are installed at respective raw material hoppers, and that other such strategies are adopted to carry out melt extrusion.

### 3.1.2. Melt Extrusion (Lamination by Co-Extrusion)

A printed layer may be obtained by causing raw materials supplied in “3.1.1. Mixing and supply of raw materials” to be melt-extruded by an extruder to form an unstretched film, and causing the film to undergo the prescribed processes indicated below. A seal layer and a substrate layer may be laminated together with the laser-printed layer in the extrusion process, and each layer can be laminated at optional timing. It is preferred to employ a co-extrusion method for lamination during melt extrusion. This is a method in which resins, which are raw materials for the respective layers, are each melt-extruded by separate extruders, and joined using a feed block or the like in the middle of a resin flow path. Extrusion lamination may be employed, in which a resin to be the seal layer is melt-extruded from a slot die and laminated in an optional process from after extrusion of the laser-printed layer to winding.

As a method for melt extruding a resin raw material, known methods may be used, and methods using an extruder equipped with a barrel and a screw are preferred. It is preferred that a hopper dryer, a paddle dryer, or other such dryer, or a vacuum dryer is used in advance to cause a raw material (polyester or polyamide or the like) that decomposes due to the effect of moisture when molten to be dried until the moisture content thereof is 100 ppm or less, more preferably 90 ppm or less, and still more preferably 80 ppm or less. After the raw material is dried in such fashion, the resin melted by an extruder is quenched, as a result of which it is possible to obtain an unstretched film. Extrusion may be carried out by adopting a T die method, a tubular method, and any other such known method.

By thereafter quenching the film that is molten due to the extrusion, it is possible to obtain an unstretched film. As a method for quenching a molten resin, a method in which the molten resin from an orifice fixture is cast onto a rotating drum where the resin is quenched and allowed to solidify to obtain a substantially unoriented resin sheet may be favorably adopted.

The film serving as a printed layer may be formed by any technique of unstretching; uniaxial stretching (stretching in at least one of the vertical (machine) direction or the horizontal (transverse) direction); biaxial stretching. However, in consideration of mechanical strength, uniaxial stretching is preferred, and biaxial stretching is more preferred. Similarly, the substrate layer is also preferably uniaxially stretched, and more preferably biaxially stretched. However, the seal layer is preferably unstretched for achievement of sealing strength. By forming a stretched film, it is possible to prevent a decrease in mechanical strength due to the use of a laser-printed pigment and to improve abrasion resistance.

While the description that follows is given with a focus on the sequential biaxial stretching method employing machine direction stretching—transverse direction stretching in which stretching is first carried out in the machine direction and stretching is subsequently carried out in the transverse direction, there is no objection to transverse direction stretching—machine direction stretching in which the order is reversed, as this merely causes a change in the principal orientation direction.

There would moreover be no objection to a simultaneous biaxial stretching method in which stretching in the machine direction and stretching in the transverse direction are simultaneously carried out.

### 3.1.3. First (Machine Direction) Stretching

Stretching in a first direction (vertical or machine direction) may be carried out by causing the film to be fed into a machine direction stretching device in which a plurality of groups of rolls are arranged in continuous fashion. In carrying out machine direction stretching, it is preferred that a preheating roll is used to carry out preheating of the film. The preheating temperature is set so as to be between a glass transition temperature Tg and a melting point Tm+50° C., as determined based on the Tg of the plastic constituting the film. When the preheating temperature is less than Tg, stretching is difficult when stretching in the machine direction is carried out, and fracture is apt to occur, which is not preferred. When the heating temperature is higher than Tm+50° C., the film is apt to stick to the roll and the film is apt to be wound around the roll, which is not preferred.

When the film reaches between Tg and Tm+50° C., stretching in the machine direction is carried out. The stretching ratio in the machine direction should be 1× or more and 5× or less. As 1× means that there is no stretching in the machine direction, the stretching ratio in the machine direction is 1× to obtain a film which is uniaxially stretched in the transverse direction, and the stretching ratio in the machine direction is 1.1× or more to obtain a biaxially stretched film. By setting the machine direction stretching ratio to be 1.1× or more, a void is formed within the printed layer, which is preferred. There is no objection to employment of any value as the upper limit of the stretching ratio in the machine direction, but when a stretching ratio in the machine direction is too great, fracture is apt to occur during the stretching in the transverse direction that follows, and therefore it is preferred that the stretching ratio in the machine direction is 10× or less. The stretching ratio in the machine direction is more preferably 1.2× or more and 9.8× or less, and still more preferably 1.4× or more and 9.6× or less.

### 3.1.4. Second (Transverse Direction) Stretching

Following the first (machine direction) stretching, it is preferred that stretching in the transverse direction is carried out at a stretching ratio of the order of 2× to 13× at between Tg and Tm+50° C. in a state where the two ends in the transverse direction (the direction perpendicular to the machine direction) of the film are gripped by clips within a tenter. Before carrying out stretching in the transverse direction, it is preferred that preheating is carried out, and preheating may be carried out until the temperature at the display material or the in-mold label surface reaches between Tg and Tm+50° C.

The stretching ratio in the transverse direction is more preferably 2.2× or more and 12.8× or less, and still more preferably 2.4× or more and 12.6× or less. Since the stretching rates are different for stretching in the machine direction and stretching in the transverse direction (the stretching rate is higher for stretching in the machine direction), the preferred stretching ratio ranges are different. It is preferred that the area ratio which is the product of the machine direction stretching and transverse direction stretching ratios is 2.2× or more and 64×.

Following the stretching in the transverse direction, it is preferred that the film is made to pass through an intermediate zone in which no active heating procedure is performed. Relative to the zone in which the stretching in the transverse direction is carried out at the tenter, the temperature at the final heat treatment zone that follows is high, and therefore failure to establish an intermediate zone causes heat (hot air itself and radiated heat) from the final heat treatment zone to flow into the process at which the stretching in the transverse direction is carried out. In this case, the temperature in the zone in which the stretching in the transverse direction is carried out is not stable, and therefore variation in physical properties occurs. It is therefore preferred that following stretching in the transverse direction, the film is made to pass through an intermediate zone until a prescribed time has elapsed before final heat treatment is performed. It is important that when in this intermediate zone, rectangular strips are made to hang down from above while the film is kept from passing therethrough, hot air from the final heat treatment zone and from the zone in which the stretching in the transverse direction is carried out as well as any concomitant flow that accompanies the movement of the film is blocked, so that the strips are made to hang down from above in almost perfectly vertical fashion. It is sufficient if the time of passage through the intermediate zone is on the order of 1 second to 5 seconds. When the time is less than 1 second, the length of time in the intermediate zone is insufficient, resulting in an inadequate heat blocking effect. Meanwhile, a time in the intermediate zone is preferably longer, but when the time therein is too long, an equipment size increases, and therefore the order of 5 seconds is sufficient.

### 3.1.5. Heat Treatment

Following passage through the intermediate zone, it is preferred at the heat treatment zone that heat treatment is carried out at between 100° C. and 280° C. Since the heat treatment promotes the crystallization of the film, a heat shrinkage rate occurring during a stretching process can be reduced, and tensile fracture strength is likely to increase. When the heat treatment temperature is less than 100° C., the heat shrinkage rate of the film is apt to increase, which is not preferred. Meanwhile, when the heat treatment temperature exceeds 280° C., the film is apt to melt, and tensile fracture strength is apt to be reduced, which is not preferred. The heat treatment temperature is more preferably between 110° C. and 270° C., and still more preferably between 120° C. and 260° C.

It is preferred that the time of passage through the heat treatment zone is 2 seconds or more and 20 seconds or less. When the time of passage therethrough is 2 seconds or less, the film passes through the heat treatment zone without the surface temperature of the film reaching a set temperature, and therefore the heat treatment is meaningless. The longer the time of passage therethrough is, the greater the effect of the heat treatment is, and therefore it is more preferred that the time is 5 seconds or more. However, attempting to increase the length of time of passage therethrough results in an increased equipment size, and therefore as a practical matter, the time is sufficient if the time is 20 seconds or less.

During the heat treatment, decreasing the distance between tenter clips (relaxation in the transverse direction) by an optional ratio makes it possible to reduce a heat shrinkage rate in the transverse direction. For this reason, it is preferred during the final heat treatment that the film is made to undergo relaxation in the transverse direction within the range 0% or more and 10% or less (a relaxation rate of 0% indicating that the film is not made to undergo relaxation). Whereas the higher the relaxation rate in the transverse direction is, the greater the reduction in the shrinkage rate in the transverse direction is, the upper limit of the relaxation rate (shrinkage rate of the film in the transverse direction immediately following the stretching in the transverse direction) is determined by the raw materials used, the conditions under which the stretching in the transverse direction is carried out, and the heat treatment temperature, and therefore it is not possible to cause the film to undergo relaxation to the point where the upper limit of the relaxation rate is exceeded. At a laser-printed layer constituting a display material in accordance with the present invention, the upper limit of the relaxation rate in the transverse direction is 10%. During the heat treatment, it is also possible to decrease the distance between clips in the machine direction by an optional ratio (relaxation in the machine direction).

### 3.1.6. Cooling

Following passage through the heat treatment zone, it is preferred at the cooling zone that a cooling airstream at 10° C. or more and 50° C. or less is used to cool the film for a passage time therethrough of 2 seconds or more and 20 seconds or less.

By thereafter causing the film to be rolled up as portions cut from the two ends thereof are removed therefrom, a film roll is obtained.

### 3.2. Lamination

When the in-mold label of the present invention is manufactured, in a case where the laser-printed layer, the heat seal layer and other layers (including a gas barrier layer, an anchor coat layer and an overcoat layer that are laminated on any layer, as necessary) are separately formed by the methods described in the “3.1. Film manufacturing conditions” and then laminated, the lamination method is not particularly limited, and adjacent layers can be laminated by conventionally known dry lamination or extrusion lamination using laminating agents such as those described in the “1.4. Laminating agent”. In order to laminate the laser-printed layer, the heat seal layer and other layers in the present invention, there is a method in which a laminating agent is applied to one of the layers, the other layer is then bonded to the coated surface, and drying is performed to volatilize the solvent. The drying conditions vary depending on the laminating agent, but the laminating agent is cured by, for example, being left to stand in an environment of 40° C. for one day or longer.

### 3.3. Gas Barrier Layer

The method for forming the gas barrier layer is not particularly limited, and known manufacturing methods can be employed as long as the object of the present invention is not impaired. Among known manufacturing methods, it is preferred to employ a vapor-deposition method. Examples of the vapor-deposition method include a vacuum vapor-deposition method, a sputtering method, a PVD (physical vapor-deposition) method such as ion plating, and a CVD (chemical vapor-deposition) method. Among these, the vacuum vapor-deposition method and the physical vapor-deposition method are preferred, and the vacuum vapor-deposition method is particularly preferred from the viewpoint of a production speed and stability. As a heating mode in the vacuum deposition method, resistance heating, high-frequency induction heating, or electron beam heating or the like can be used. Oxygen, nitrogen, or water vapor or the like may be introduced as a reactive gas, or reactive vapor-deposition using means such as ozone addition or ion assist may be used. The film forming conditions may be changed, such as applying a bias to the substrate, raising the temperature of the substrate, or cooling the substrate, as long as the object of the present invention is not impaired.

Here, a method for forming a gas barrier layer by a vacuum deposition method will be described. When a gas barrier layer is formed, the in-mold label of the present invention is conveyed to a gas barrier layer manufacturing apparatus via a metal roll. As an example of the configuration of the gas barrier layer manufacturing apparatus, the apparatus includes an unwinding roll, a coating drum, a winding roll, an electron beam gun, a crucible, and a vacuum pump. The in-mold label is set on the unwinding roll, passes through the coating drum, and is wound around the winding roll. The pressure in the pass line of the in-mold label (inside the gas barrier layer manufacturing apparatus) is reduced by the vacuum pump, and an inorganic material set in the crucible is vaporized by a beam emitted from the electron gun and deposited onto the in-mold label that passes through the coating drum. During the deposition of an inorganic material, the in-mold label is subjected to heat and tension between the unwinding roll and the winding roll. When the temperature applied to the in-mold label is too high, the in-mold label undergoes not only great heat shrinkage but also softening, and thus elongation deformation due to tension is apt to occur. Moreover, the temperature drop (cooling) of the in-mold label after the vapor-deposition process is large, the amount of shrinkage after expansion (different from heat shrinkage) is large, the gas barrier layer cracks, and the desired gas barrier properties are less likely to be exerted, which is not preferred. Meanwhile, as the temperature applied to the in-mold label is lower, the deformation of the in-mold label is suppressed, which is preferred, but the amount of an inorganic material vaporized decreases, resulting in a decrease in the thickness of the gas barrier layer, and therefore there is a concern that the desired gas barrier properties are not achieved. The temperature applied to the in-mold label is preferably 100° C. or more and 180° C. or less, more preferably 110° C. or more and 170° C. or less, and still more preferably 120° C. or more and 160° C. or less.

In a case where an aluminum foil is bonded as an opaque gas barrier layer, the aluminum foil can be bonded by the method mentioned in the “1.4. Adhesive layer”.

### 3.4. Overcoat Layer

When an overcoat layer is formed, the in-mold label is conveyed to the coating equipment via a metal roll. Examples of an equipment configuration include an unwinding roll, a coating process, a drying process, and a winding process. At the time of overcoating, the in-mold label set on the unwinding roll is subjected to the coating process and the drying process via the metal roll and finally led to the winding roll. The coating method is not particularly limited, and conventionally known methods, such as a gravure coating method, a reverse coating method, a dipping method, a low coating method, an air knife coating method, a comma coating method, a screen printing method, a spray coating method, a gravure offset method, a die coating method, and a bar coating method, can be employed, and the coating method can be appropriately selected according to the desired purpose. Among these, a gravure coating method, a reverse coating method, and a bar coating method are preferred from the viewpoint of productivity. As the drying method, one heating method or a combination of two or more heating methods, such as hot air drying, hot roll drying, high frequency irradiation, infrared irradiation, and UV irradiation, can be used.

In the drying process, the in-mold label is heated and also subjected to tension between the metal rolls. When the temperature at which the in-mold label is heated in the drying process is too high, the in-mold label undergoes not only great heat shrinkage but also softening, and therefore elongation deformation due to tension is apt to occur, and the gas barrier layer of the in-mold label is apt to crack. Moreover, the temperature drop (cooling) of the in-mold label after the drying process is large, accordingly the amount of shrinkage after expansion (different from heat shrinkage) is large, the gas barrier layer and the overcoat layer crack, and the desired gas barrier properties are less likely to be achieved, which is not preferred. Meanwhile, as the temperature at which the in-mold label is heated is lower, the deformation of the in-mold label is suppressed, which is preferred, but the solvent of the coating liquid is less likely to be dried, and therefore there is a concern that the desired gas barrier properties are not achieved. The temperature at which the in-mold label is heated is preferably 60° C. or more and 200° C. or less, more preferably 80° C. or more and 180° C. or less, and still more preferably 100° C. or more and 160° C. or less.

3.5. Bonding with Container

As a method for bonding the in-mold label of the present invention with the container, for example, known conventional techniques such as blow molding and injection molding can be optionally adopted. As an example, an in-mold label is inserted into a mold, vacuum-sucked, and positioned. Then, a resin to be a container is flown into the mold and thermally formed, and thermal bonding is also performed, and therefore the container with in-mold label is manufactured. The shape of the container, the shape of the in-mold label (diameter, height), and the conditions for forming the container (bonding of the in-mold label) are not particularly limited, and can be freely set without departing from the gist of the present invention.

### 3.6. Laser-Printed Layer

Examples of types (wavelengths) of lasers that may be used to carry out laser printing on the in-mold label of the present invention include CO2 lasers (10600 nm), YAG lasers (1064 nm), YVO₄ lasers (1064 nm), fiber lasers (1064 nm and 1090 nm), green lasers (532 nm), and UV lasers (355 nm). Among these, while there is no particular limitation with respect to the type of laser used at printing of the present invention, and CO2 lasers are often used for ablation of plastic. As the CO2 lasers are often used for a purpose that is different from printing which is the intention of the present invention, the CO2 lasers are not preferred as a laser source. As the laser source, YAG lasers, YVO₄ lasers, fiber lasers, green lasers, and UV lasers are preferred, and YAG lasers, fiber lasers, and UV lasers are more preferred. Commercially available devices may be used for laser printing, and representative examples thereof include LM-2550 (YAG laser) manufactured by Brother Industrial Printing, Ltd.; MX-Z2000H-V1 (fiber laser) manufactured by Omron Corporation; 8028 Trotec Speedy 100 flexx (fiber laser) manufactured by Trotec; MD-X1000 (YVO4 laser), and MD-U1000C (UV laser) manufactured by Keyence Corporation.

Regarding laser printing conditions, while specifications and conditions that may be established will differ for each device manufacturer and for each model, and will moreover differ depending on the film on which printing is carried out, for which reason it is impossible to speak to every situation, the following will apply where MD-U1000C (UV laser; wavelength 355 nm) manufactured by Keyence Corporation is employed by way of example.

It is preferred that laser power is such that output is 20% or more and 80% or less of the maximum 13 W specified for the device. When the output is less than 20%, printing density is reduced, and visual perceivability is reduced, which is not preferred, When the output is 80% or more, perforation occurs in the display body, which is not preferred. The output is more preferably 25% or more and 75% or less, and still more preferably 30% or more and 70% or less. It is preferred that a pulse frequency is 10 kHz or more and 100 kHz or less. When the frequency falls below 10 kHz, laser energy per irradiation is high, and the decrease rate of the thickness at the printed portion is apt to exceed 80 vol %, which is not preferred. Conversely, when the frequency exceeds 100 kHz, the decrease rate of the thickness at the printed portion is apt to be 80 vol % or less, but it may be difficult to set a difference between color L* values at the printed portion to 1 or more. The frequency is more preferably 15 kHz or more and 95 kHz or less, and still more preferably 20 kHz or more and 90 kHz or less. It is preferred that a scan speed is 10 mm/sec or more and 3000 mm/sec or less. When the scan speed falls below 10 mm/sec, a printing speed is extremely low, and therefore the production rate of the display body is reduced, which is not preferred. Meanwhile, when the scan speed exceeds 3000 mm/sec, the printing density is reduced, and a difference between color L* values is less likely to be set to 1 or more, which is not preferred. The scan speed is more preferably 100 mm/sec or more and 2900 mm/or less, and still more preferably 200 mm/sec or more and 2800 mm/or less.

The timing of performing laser printing on the in-mold label of the present invention is not particularly limited, and may be either before or after bonding (thermally forming) with the container.

### EXAMPLES

Next, although the present invention is specifically described by way of Examples and Comparative Examples, the present invention is not limited to the aspects of these Examples at all, and can be appropriately modified without departing from the gist of the present invention.

### <Polyolefin Raw Materials>

### <Polyolefin A>

As Polyolefin A, FS2011DG3 manufactured by Sumitomo Chemical Co., Ltd., was used.

### <Polyolefin B>

As Polyolefin B, FS7053G3 manufactured by Sumitomo Chemical Co., Ltd., was used.

### <Polyolefin C>

60% by mass of CaCO3 was kneaded into Polyolefin A to obtain Polyolefin C.

### <Polyolefin D>

60% by mass of TiO₂ was kneaded into Polyolefin A to obtain Polyolefin D.

### <Polyester Raw Materials>

### [Polyester A]

As Polyester A, RE553 manufactured by Toyobo Co., Ltd., was used.

### [Polyester B]

As Polyester B, 50% by mass of TiO₂ was kneaded into Polyester A to obtain Polyester B.

### [Polyester C]

As Polyester C, Polyester A and “Tomatec Color 42-920A (primary constituent Bi₂O₃)” laser pigment (manufactured by Tokan Material Technology Co., Ltd.) were mixed (dry blended) at a mass ratio of 95:5, and the mixture was fed into a screw-type extruder, where the mixture was heated at 275° C. and melt blended. This molten resin was expelled with a cylindrical shape in continuous fashion from a strand die, and the expelled product was cut at a strand cutter to obtain chip-like Polyester C (masterbatch).

### [Polyester D]

As Polyester D, RE555 (masterbatch into which 7000 ppm of SiO2 was kneaded) manufactured by Toyobo Co., Ltd., was used.

Respective polyolefin raw material and polyester raw material compositions are shown in Table 1.

TABLE 1

| Name of raw | | Laser-printed pigment | | |
|---|---|---|---|---|
| material | Resin type | Type | Amount added | |
| Polyolefin A | Polypropylene | None | — | |
| Polyolefin B | Propylene-ethylene copolymer | None | — | |
| Polyolefin C | Polypropylene | CaCO₃ | 60 | wt % |
| Polyolefin D | Polypropylene | TiO₂ | 60 | wt % |
| Polyolefin E | Polymethylpentene 70 wt | None | — | |
| | %/polystyrene 30 wt % | | | |
| Polyester A | Polyethylene terephthalate | None | — | |
| Polyester B | Polyethylene terephthalate | TiO₂ | 50 | wt % |
| Polyester C | Polyethylene terephthalate | Bi₂O₃ | 5 | wt % |
| Polyester D | Polyethylene terephthalate | SiO₂ | 7000 | ppm |

### [Film 1]

Polyolefin A, Polyolefin C, and Polyolefin D were mixed at a mass ratio of 35:50:15 as a raw material for Layer A; Polyolefin A, Polyolefin B, and Polyolefin C were mixed at a mass ratio of 10:70:20 as a raw material for Layer B.

The raw materials mixed for Layer A and Layer B were respectively fed into different screw-type extruders, melted, and extruded from a T die. A feedblock was used partway along the flow paths of the respective molten resins so as to cause the molten resins to be joined, and this was expelled from a T die and taken up at a draft ratio of 1.2 as it was cooled on a chill roll, the surface temperature of which was set to 30° C., to obtain an unstretched laminated film. Molten resin flow paths were established so as to cause the laminated film to be such that the central layer thereof was Layer A, and the two surfacemost layers thereof were Layer B (i.e., a B/A/B constitution in which there were three layers of two types), and the amounts expelled therefrom were adjusted so as to cause the thickness ratio of Layer A and Layer B to be 90/10 (B/A/B=5/90/5).

The cooled and solidified unstretched laminated film was guided to a machine direction stretching device in which a plurality of groups of rolls were arranged in continuous fashion, and the laminated film was made to undergo preheating on preheating rolls until the film temperature reached 125° C., followed by stretching by a factor of 4×.

Following machine direction stretching, the film was guided to a transverse direction stretching device (tenter), where the film was made to undergo preheating for 8 seconds until the surface temperature thereof reached 160° C., followed by stretching by a factor of 9.8× in the transverse direction (horizontal direction). Following transverse direction stretching, the film was guided while still in that state to an intermediate zone, and was made to pass therethrough in 1.0 second. In the intermediate zone of the tenter, when rectangular strips were made to hang down from above while the film was kept from passing therethrough, hot air from the heat treatment zone and hot air from the zone in which stretching in the transverse direction was carried out were blocked, so that the strips were made to hang down from above in almost perfectly vertical fashion.

Thereafter, following passage through the intermediate zone, the film was guided to the heat treatment zone, where heat treatment was carried out for 9 seconds at 165° C. At this time, at the same time that heat treatment was carried out, the distance between clips in the transverse direction of the film was reduced, causing the film to undergo 3% relaxation treatment in the transverse direction. Following passage through the final heat treatment zone, the film was cooled for 5 seconds in a cooling airstream at 30° C. Portions were cut and removed from the two edges thereof and this was rolled up into a roll 400 mm in width to continuously manufacture a prescribed length of a biaxially stretched film having a thickness 70 μm. The properties of the obtained film were evaluated in accordance with the foregoing methods. The manufacturing conditions are shown in Table 2.

### [Films 2 to 4]

In similar fashion as at Film 1, various conditions were altered to continuously form films at Films 2 to 4. The manufacturing conditions for the respective films are shown in Table 2.

### [Films 5 to 8]

A non-stretched polypropylene film, Pylen film CT (registered trademark) P1128-30 μm, manufactured by Toyobo Co., Ltd., was used for Film 5;
a non-stretched linear low-density polyethylene film, LIX film (registered trademark) L4102-30 μm, manufactured by Toyobo Co., Ltd., was used for Film 6;
a biaxially stretched polyethylene terephthalate film, Ester film (registered trademark) E5102-12 μm, manufactured by Toyobo Co., Ltd., was used for Film 7; and
a biaxially stretched polyamide film, Harden film (registered trademark) N1102-15 μm, manufactured by Toyobo Co., Ltd. was used for Film 8.

Names of the respective films are shown in Table 2.

### Example 1

Film 5 was bonded on Film 1 by dry lamination using a urethane-based two-pack curing adhesive (“TAKELAC (registered trademark) A525S” and “TAKENATE (registered trademark) A50” manufactured by Mitsui Chemicals, Inc. were blended at a weight ratio of 13.5:1), and aging was performed at 40° C. for 4 days to obtain an in-mold label. At this time, the thickness of the adhesive layer was 3 μm.

Next, the in-mold label obtained above was inserted into a predetermined position of a female mold of an injection forming mold, and fixed by vacuum suction. mold was closed, molten polyethylene was injected from a gate at the center of the bottom of the female mold to obtain a container with label in which the in-mold label and the injection resin were integrated.

“12345ABCDE” was printed in the center of the film of the label portion of the obtained container with label at a pulse frequency of 40 kHz, a scanning speed of 2000 mm/min, and an output of 30% using a UV laser with a wavelength of 355 nm (Laser Marker MD-U1000C manufactured by Keyence Corporation). The size per character was approximately 5 mm in height×approximately 3 mm in width.

The layer configuration and physical property evaluation results for the obtained in-mold label are shown in Table 3.

### Example 2

An aluminum oxide (Al₂O₃) thin film was formed as a gas barrier layer on one side of Film 7 using aluminum as a vapor-deposition source by a vacuum deposition method while oxygen gas was introduced using a vacuum vapor-deposition machine. The thickness of the gas barrier layer was 10 nm. The gas barrier layer side of Film 7 and Film 1 were bonded together in the same manner as in Example 1. Film 6 was further bonded on the Film 1 side of the bonded films in the same manner as the above to fabricate an in-mold label.

Using this in-mold label, a container with label was fabricated in the same manner as in Example 1. “12345ABCDE” was printed in the center of the film of the label portion at a pulse frequency of 30 kHz, a scanning speed of 1500 mm/min, and an output of 80% using a fiber laser with a wavelength of 1064 nm (Laser Marker 8028 Trotec Speedy 100 flexx manufactured by Trotec). The size per character was approximately 8 mm in height×approximately 5 mm in width.

The layer configuration and physical property evaluation results for the obtained in-mold label are shown in Table 3.

### Examples 3 to 6, Comparative Examples 1 and 2

In similar fashion as at Example 1 or 2, the type of a film used and laser source/irradiation conditions were variously altered to fabricate containers with labels of Examples 3 to 6 and Comparative Examples 1 and 2. MD-U1000C Laser Marker manufactured by Keyence Corporation was employed in all cases where a UV laser was used, and 8028 Trotec Speedy 100 flexx Laser Marker manufactured by Trotec was employed in all cases where a fiber laser was used.

Since the print size of Comparative Example 2 was 150 mm×150 mm, the printed characters were only “B”.

The layer configuration and physical property evaluation results for the obtained in-mold label are shown in Table 3.

### <Method for Evaluating In-Mold Label>

The evaluation methods of an in-mold label are as follows. For samples of a non-printed portion, the samples used were cut out from portions that were 1 mm or more away from any printed portion or sealed portion.

### [Thickness]

The label was peeled off from the container. The thicknesses were measured at five points in the non-printed portion using a micrometer (Millitron 1254D manufactured by Feinpruf GmbH), and the average value thereof was determined.

When it was difficult to peel off the label from the container, the sample was cut out together with the container with label, and the thickness of the non-printed portion was measured by microscopically observing the cross section of the sample. Specifically, the sample size was set to 5 mm in the height direction of the container×1 mm in the circumferential direction, and the cross section of the non-printed portion was determined using a microtome. When the cross section was not determined due to insufficient rigidity of the sample at cutting with the microtome, Ester film (registered trademark) E5100-100 μm manufactured by Toyobo Co., Ltd. was bonded to both surface layers of the sample with a two-pack epoxy adhesive (EP001N manufactured by Cemedine Co., Ltd.) to fabricate an embedded sample for cross-section observation. The cross-section of the embedded sample was cut with the microtome. The cross section of the sample was observed using a digital microscope RH-2000 manufactured by Hirox Co., Ltd., and the thickness of the non-printed portion was measured. Software attached to RH-2000 digital microscope manufactured by Hirox Co., Ltd. was used for measurement. This operation was repeated three times, and the average value thereof was taken to be the thickness of the non-printed portion.

### [Color L* Value (Printed Portion and Non-Printed Portion)]

The label was peeled off from the container, and a spectroscopic color difference meter (ZE-6000; manufactured by Nippon Denshoku Industries Co., Ltd.) was used to respectively measure color L* values at the printed portion and the non-printed portion according to a reflection method. When it was difficult to remove the label from the container, the entire container with the label was cut out and used as a measurement sample. The specific method used for measurement of the printed portion was as follows.

A 3 cm square sample was cut out so as to include the entire character “B” among the characters printed as “12345ABCDE”, and the measurement was performed. At this time, characters other than “B” may be included, and when the character size exceeds 3 cm, a part of “B” may be included. The light source for measurement at the color difference meter employed a 6φ stage (the aperture on which light for measurement fell being approximately 1 cm in diameter) and a 69 eyepiece, and the aperture of the stage was arranged so as to contain the character “B” therewithin. In a case where printing is not completely contained within (i.e., protruded from) the stage aperture, the stage may be changed as necessary (e.g., 109, 309, etc.). Even where printing protrudes therefrom, a portion of printing may be contained within the stage aperture so that light for measurement falls thereon.

For the non-printed portion, a square sample which was 3 cm on a side was cut from the portion at which printing had not been carried out, and color L* values were measured using 69 components at the stage and eyepiece of the color difference meter. The stage and eyepiece of the color difference meter may be changed to 109, 309, or the like as necessary, in which case an optional sample size may be employed so long as the aperture of the stage is covered (i.e., so long as light for measurement does not leak past the aperture).

### [Print Size]

Among the characters printed as “12345ABCDE”, a stainless steel straightedge ruler (TZ-RS15 manufactured by Kokuyo Co., Ltd.) was used to measure by visual inspection in increments of 0.5 mm the heights and widths of those at “345ABC”, and the average thereof was taken to be the print size. Where the print size was less than 0.5 mm, an RH-2000 digital microscope manufactured by Hirox Co., Ltd. was separately used to measure the print size. Software attached to an RH-2000 digital microscope manufactured by Hirox Co., Ltd. was used for measurement of the print size.

In a case where there is one printing (only “B” or the like), the size of the character was taken to be the print size.

[Bonding Strength with Container]

The container was cut out together with the label, and bonding strength between the container and the label was measured. Specifically, measurement conditions are as follows.

A sample was cut out from a container with label in a size of 100 mm in the height direction of the container×25 mm in the circumferential direction. A label as a portion to be gripped with a chuck was peeled off by about 20 mm from an end in the height direction of the cut sample to obtain a sample for measuring bonding strength. Next, the bonding strength of this sample was measured at a distance between chucks of 50 mm and a tensile speed of 100 mm/min, and a peeling angle of 180 degrees using a universal tensile tester “Autograph AG-Xplus” (manufactured by Shimadzu Corporation). The maximum peel strength obtained before completion of peeling in each sample was defined as the bonding strength of each sample, and the average value of the five samples was calculated as the bonding strength. The peel strength is indicated by strength per 25 mm (N/25 mm).

When the sample cannot be cut out with a length of 100 mm or more due to limitations on the size of the in-mold label, the length may be 100 mm or less (for example, 20 mm). In this case, the distance between chucks may be set to 50 mm or less (for example, the distance between chucks is 10 mm in a case where the sample length is 20 mm) as long as the chuck on one side is provided with at least a length of 5 mm or more for gripping the sample.

### [Tensile Fracture Strength]

The label was peeled off from the container, and the tensile fracture strength of the label was measured in accordance with JIS K7113. The sample size was a strip shape with a measurement direction of 140 mm and a direction orthogonal to the measurement direction of 20 mm. An “Autograph AG-Xplus” universal tensile tester (manufactured by Shimadzu Corporation) was used, and both the ends of the test piece were held such that a 20 mm length thereof was gripped by a chuck at either end (chuck separation: 100 mm). Tensile testing was carried out under conditions of 23° C. ambient temperature and 200 mm/min elongation rate, and strength (stress) at the time of tensile fracture was taken to be the tensile fracture strength (MPa). The height direction and the circumferential direction of the container were used as measurement directions.

### [Water Vapor Transmission Rate]

The water vapor transmission rate was measured in conformity with JIS K7126 B method. The label was peeled off from the container, and using a water vapor transmission rate measuring apparatus (PERMATRAN-W3/33MG manufactured by MOCON), in an atmosphere of a temperature of 40° C. and a humidity of 90% RH, the water vapor transmission rate was measured in a direction in which the moisture-regulating gas was transmitted from the heat seal layer side (inner side) to the outside of the in-mold label. Before measurement, the sample was left to stand for 4 hours in an environment having a humidity of 65% RH to condition the humidity.

### [Oxygen Transmission Rate]

The oxygen transmission rate was measured in conformity with JIS K7126-2 method. The label was peeled off from the container, and the oxygen transmission rate was measured in a direction in which oxygen permeated from the heat seal layer side (inner side) of the in-mold label to the outer side under an atmosphere of a temperature of 23° C. and a humidity of 65% RH using an oxygen permeation amount measuring apparatus (OX-TRAN 2/20 manufactured by MOCOM). Before measurement, the sample was left to stand for 4 hours in an environment having a humidity of 65% RH to condition the humidity.

### [Visual Evaluation of Printed Portion]

The visual perceptibility of the characters that were printed on the in-mold label was determined based on the following criteria.

Good Characters were recognizable as a result of visual inspection

Poor Characters were unrecognizable as a result of visual inspection

TABLE 2

| | | Film 1 | Film 2 | Film 3 | Film 4 | Film 5 | Film 6 | Film 7 | Film 8 |
|---|---|---|---|---|---|---|---|---|---|
| Raw material | Polyolefin A | 35 | 50 | 0 | 0 | F1128 | L4102 | E5102 | N1102 |
| composition | Polyolefin B | 0 | 0 | 0 | 0 | | | | |
| of layer A | Polyolefin C | 50 | 25 | 0 | 0 | | | | |
| [% by mass] | Polyolefin D | 15 | 25 | 0 | 0 | | | | |
| | Polyolefin E | 0 | 0 | 7 | 0 | | | | |
| | Polyester A | 0 | 0 | 88 | 90 | | | | |
| | Polyester B | 0 | 0 | 5 | 0 | | | | |
| | Polyester C | 0 | 0 | 0 | 3 | | | | |
| | Polyester D | 0 | 0 | 0 | 7 | | | | |
| Raw material | Polyolefin A | 10 | 30 | 0 | — | | | | |
| composition | Polyolefin B | 70 | 70 | 0 | — | | | | |
| of layer B | Polyolefin C | 20 | 0 | 0 | — | | | | |
| [% by mass] | Polyolefin D | 0 | 0 | 0 | — | | | | |
| | Polyolefin E | 0 | 0 | 0 | — | | | | |
| | Polyester A | 0 | 0 | 60 | — | | | | |
| | Polyester B | 0 | 0 | 30 | — | | | | |
| | Polyester C | 0 | 0 | 0 | — | | | | |
| | Polyester D | 0 | 0 | 10 | — | | | | |
| Laser pigment | Type | TiO₂/CaCO₃ | TiO₂/CaCO₃ | TiO₂ | Bi₂O₃ | | | | |
| of layer A | Amount added [wt %] | 9.0/30 | 15/15 | 2.5 | 0.15 | | | | |
| Laser pigment | Type | CaCO₃ | None | TiO₂ | — | | | | |
| of layer B | Amount added [wt %] | 12 | — | 15 | — | | | | |
| Layer configuration | | B/A/B | B/A/B | B/A/B | A | | | | |
| Thickness ratio among | | 5/90/5 | 20/60/20 | 25/50/25 | 100 | | | | |
| respective layers [vol %] | | | | | | | | | |
| Stretching | Temperature for | 125 | 120 | 90 | 90 | | | | |
| in machine | stretching [° C.] | | | | | | | | |
| direction | Stretching ratio | 4.0 | 4.7 | 3.1 | 3.5 | | | | |
| (machine | | | | | | | | | |
| direction | | | | | | | | | |
| stretching) | | | | | | | | | |
| Stretching | Temperature for | 160 | 145 | 125 | 105 | | | | |
| in transverse | stretching [° C.] | | | | | | | | |
| direction | Stretching ratio | 9.8 | 10.1 | 4.2 | 3.8 | | | | |
| (transverse | | | | | | | | | |
| direction | | | | | | | | | |
| stretching) | | | | | | | | | |
| Heat treatment | Temperature [° C.] | 165 | 160 | 230 | 230 | | | | |
| | Relaxation rate | 3 | 8 | 6 | 3 | | | | |
| | (transverse | | | | | | | | |
| | direction) [%] | | | | | | | | |

| | | | | | | | | |
|---|---|---|---|---|---|---|---|---|
| Film thickness [μm] | 70 | 35 | 100 | 50 | 30 | 30 | 12 | 15 |

TABLE 3

| | | | Example 1 | Example 2 | Example 3 | Example 4 | Example 5 |
|---|---|---|---|---|---|---|---|
| Layer | Outer side | Substrate layer | — | Film 7 | — | Film 7 | Film 8 |
| configuration | | Gas barrier layer | — | Al₂O₃ | — | — | Al₂O₃/SiO2 |
| | | Bonding layer | Urethane- | Urethane- | Urethane- | Urethane- | Urethane- |
| | | | based | based | based | based | based |
| | | | 3 μm | 3 μm | 3 μm | 3 μm | 3 μm |
| | | Laser printed layer | Film 1 | Film 1 | Film 2 | Film 3 | Film 4 |
| | | Bonding Layer | Urethane- | Urethane- | Urethane- | Urethane- | Urethane- |
| | | | based | based | based | based | based |
| | | | 3 μm | 3 μm | 3 μm | 3 μm | 3 μm |
| | Inner side | Heat seal layer | Film 5 | Film 6 | Film 5 | Film 5 | Film 5 |
| | | Total thickness (μm) | 105 | 102 | 88 | 148 | 101 |

| Laser | Laser source | UV | Fiber | UV | Fiber | Fiber |
|---|---|---|---|---|---|---|
| irradiation | Pulse frequency [kHz] | 40 | 30 | 40 | 45 | 50 |
| condition | Scan speed [mm/min] | 2000 | 1500 | 2000 | 800 | 1500 |
| | Output [%] | 30 | 80 | 30 | 30 | 30 |
| Print size | Height [mm] | 5 | 8 | 1 | 7 | 5.5 |
| | Width [mm] | 3 | 5 | 1 | 7 | 4.5 |
| Color | Printed portion | 94.8 | 95.3 | 89.7 | 88.5 | 83.9 |
| L* value | Non-printed portion | 97.1 | 96.4 | 97.5 | 95.3 | 92.4 |
| | Difference | 2.3 | 1.1 | 7.8 | 6.8 | 8.5 |
| Bonding strength with container [N/15 mm] | | 5.3 | 4.2 | 5.6 | 6.7 | 3.2 |
| Tensile fracture | Height direction of container | 65 | 222 | 67 | 245 | 198 |
| strength [MPa] | Circumferential direction of | 164 | 231 | 157 | 275 | 228 |
| | container | | | | | |
| Gas barrier | Water vapor transmission rate | 5 | 1.5 | 6 | 6 | 1.3 |
| properties | (g/m² · d) | | | | | |
| | Oxygen transmission rate | 389 | 1.2 | 401 | 9 | 0.9 |
| | (cc/m² · d · atm) | | | | | |

| | | | | | |
|---|---|---|---|---|---|
| Visual evaluation of printed portion | ∘ | ∘ | ∘ | ∘ | ∘ |
| (visual perceivability) | | | | | |

| | | | | Comparative | Comparative |
|---|---|---|---|---|---|
| | | | Example 6 | Example 1 | Example 2 |
| Layer | Outer side | Substrate layer | Film 8 | Film 7 | Film 7 |
| configuration | | Gas barrier layer | Al | — | Al₂O₃ |
| | | Bonding layer | Urethane- | — | Urethane- |
| | | | based | | based |
| | | | 3 μm | | 3 μm |
| | | Laser printed layer | Film 1 | — | Film 1 |
| | | Bonding Layer | Urethane- | Urethane- | Urethane- |
| | | | based | based | based |
| | | | 3 μm | 3 μm | 3 μm |
| | Inner side | Heat seal layer | Film 6 | Film 5 | Film 6 |
| | | Total thickness (μm) | 101 | 45 | 102 |

| Laser | Laser source | Fiber | UV | Fiber |
|---|---|---|---|---|
| irradiation | Pulse frequency [kHz] | 60 | 40 | 30 |
| condition | Scan speed [mm/min] | 2000 | 2000 | 400 |
| | Output [%] | 30 | 30 | 80 |
| Print size | Height [mm] | 9 | No printing | 150 |
| | Width [mm] | 10 | No printing | 150 |
| Color | Printed portion | 91.2 | 96.3 | 84.2 |
| L* value | Non-printed portion | 94.2 | 96.3 | 96.4 |
| | Difference | 3 | 0 | 12.2 |
| Bonding strength with container [N/15 mm] | | 4.5 | 4.5 | 3.6 |
| Tensile fracture | Height direction of container | 255 | 210 | 230 |
| strength [MPa] | Circumferential direction of | 275 | 222 | 242 |
| | container | | | |
| Gas barrier | Water vapor transmission rate | 0.5 | 38 | 1.5 |
| properties | (g/m² · d) | | | |
| | Oxygen transmission rate | 0.5 | 98 | 1.2 |
| | (cc/m² · d · atm) | | | |

| | | | |
|---|---|---|---|
| Visual evaluation of printed portion | ∘ | x | ∘ |
| (visual perceivability) | | | |

### [Manufacturing Conditions and Evaluation Results of Film]

All of the in-mold labels of Examples 1 to 6 were excellent in the physical properties shown in Table 3.

Meanwhile, in Comparative Example 1, the in-mold label did not include a laser-printed layer, and therefore printing by laser was not possible, and the in-mold label was not preferred as a laser-printed in-mold label.

In Comparative Example 2, the difference between the color L* values exceeded 10.0, and the print size was 150 mm, which was counter-intuitive and was not preferred in view of the reduction in the print size, which was a problem of the present invention.

### INDUSTRIAL APPLICABILITY

Since the in-mold label of the present invention can recognize contents even if the print size is reduced, there is a possibility that all desired display contents can be displayed even if the container is downsized, which makes it possible to preferably meet recent demands for waste reduction and the like.

1. An in-mold label comprising at least one laser-printed layer capable of being printed by laser irradiation, wherein the laser-printed layer includes a laser-printed portion and a non-printed portion, and an absolute value of a difference between color L* values of the printed portion and the non-printed portion is 1.0 or more and 10.0 or less.

2. The in-mold label according to claim 1, wherein at least one of bismuth, gadolinium, neodymium, titanium, antimony, tin, and aluminum as a simple substance or an oxide is contained as a metal capable of being printed by laser irradiation.

3. The in-mold label according to claim 1, wherein a thickness of the laser-printed layer is 5 μm or more and 200 μm or less.

4. The in-mold label according to claim 1, wherein either a height or a width of a print size in the printed portion is 0.2 mm or more and 100 mm or less.

5. The in-mold label according to claim 1, wherein a resin constituting the laser-printed layer is mainly any one of polyester, polypropylene, polyethylene, and polystyrene.

6. The in-mold label according to claim 1, wherein the in-mold label is bonded to a container, and has bonding strength with the container of 2 N/15 mm or more and 20 N/15 mm or less.

7. A container with in-mold label, wherein the in-mold label according to claim 6 is bonded to the container.
